(19) United States
(12) Patent Application Publication
(10) Pub. No.: US 2009/0090458 A1
(43) Pub. Date: Apr. 9, 2009

(54) Method and apparatus for joining two webs of material

(76) Inventor: Karl Deininger, Murzzuschlag (AT)

Correspondence Address: COLLARD & ROE, P.C., 1077 NORTHERN BOULEVARD, ROSLYN, NY, 11576, US

(21) Appl. No.: 11/989,566

(22) PCT Filed: Jul. 28, 2006
(86) PCT No.: PCT/AT2006/000324

§ 371 Date: Mar. 12, 2008

(30) Foreign Application Priority Data
Jul. 29, 2005 (AT) A 1286/2005
Jul. 29, 2005 (AT) A 1287/2005

(51) Int. Cl. B32B 37/00

(52) U.S. Cl. 156/157; 156/459

(57) ABSTRACT

Method and device for bonding the outgoing end section (3) of a first material web (1), which extends in a horizontal transport plane (T) along a horizontal transport direction (t) over a web-processing machine, to the incoming starting section (4) of a second material web (2), which is located in a reserve area (27). An intake device (9) is provided for this purpose, in which an end section (3) of the first material web (1) implemented as a free end is held horizontally at the end, the intake device (9) being equipped with a bonding device (10) movable parallel to the transport direction (t) underneath the transport plane (T) for the tension-resistant bonding of the end section (3) to the starting section (4), which presses flatly overlapping against the end section (3). In particular according to the present invention, the starting section (4) is pressed flatly overlapping against the end section (3) by a vertical movement component of the pre-tensioning unit (8) in relation to the intake device (9).

The present invention relates to a method for bonding the outgoing end section of a first material web, which is supplied to a web-processing machine in a transport plane along a transport direction, to the incoming starting section of a second material web, which is led to the end section of the first material web from a reserve area, according to the preamble of claim 1.

Furthermore, the present invention relates to a device for bonding the outgoing end section of a first material web, which extends in a horizontal transport plane along a horizontal transport direction over a web-processing machine, to the incoming starting section of a second material web, which is located in a reserve area, according to the preamble of claim 4.

The material web may be, for example, a web-shaped film or also a web-shaped film bag. Web-shaped materials of this type are typically wound onto material rolls, they being unwound from the material rolls in the course of the processing in web-processing machines and then being processed into bags in bagging plants, for example, or being used for packaging products in packaging plants. The reserve area of the material rolls is a roll changer, for example. Roll changers are essentially support frames which have receptacles for the rotatable mounting of material rolls. If a material roll is consumed, a new material roll is brought into position, which is either located on a new roll changer, or multiple material rolls are held in one roll changer.

Thus, for example, roll changers for feeding a material web wound on a material roll into a web-processing machine are known, in which multiple material rolls are each held parallel to one another, and which are situated so they are pivotable around a shared pivot axis parallel to the rotational axes of the material rolls. By situating multiple material rolls, which are pivotable around a shared pivot axis, in a roll changer, it is possible in particular to replace a material roll of the roll changer while the web-processing machine is served by another material roll. Roll changers of this type are also referred to in the following as drum magazines.

Upon the complete consumption of a material roll, the problem arises of replacing the material roll. For this purpose, typically the web-processing machine is stopped, the consumed material roll is removed, and instead a new material roll is provided. The starting section of the new material roll is then inserted into an immobile pre-tensioning station, usually manually, and fed to the web-processing machine. Finally, in downstream plant sections of the web-processing machine, the starting and end sections are bonded to one another by various methods, such as welding, gluing, or clamping. However, the replacement of a material roll requires comparatively long shutdown times of the web-processing machine.

It is therefore the object of the present invention to avoid longer shutdown times of the entire plant upon a change of the material roll. In particular, the bonding of the starting section of a new material roll to the end section of a consumed material roll is to occur automatically. The type of bond production between starting and end sections is also to be applicable to the drum magazines described above, i.e., to a stockpile of the material rolls, in which the new material roll is fed to the end section via a pivot movement.

These objects are achieved by the features of claims 1 and 4.

Claim 1 relates to a method for bonding the outgoing end section of a first material web, which is supplied to a web-processing machine in a transport plane along a transport direction, to the incoming starting section of a second material web, which is led to the end section of the first material web from a reserve area, the end section being bent in a plane inclined to the transport plane in a first step, the starting section being pressed flatly overlapping against the end section in a second step, so that the transverse edge of the starting section and the transverse edge of the end section delimit a two-layer material web section, and the starting section and the end section being bonded to one another in a tension-resistant way by a bonding device moved parallel to the transport direction in a third step. According to the present invention, the end section is implemented as a free end of a first material web held horizontally at the end in an intake device, and the starting section is implemented as a free end of the second material web held at the beginning in a pre-tensioning unit, the starting section being pressed flatly overlapping against the end section via a vertical movement component of the pre-tensioning unit in relation to the intake device.

The bonding device is thus moved parallel to the transport direction, and not perpendicular to the transport direction, as is the case if starting and end sections are merely laid one on top of another and subsequently bonded. The material web which lies inside the transport plane must therefore first be bent out of the transport plane in the direction of the bonding device, so that the end section extends up into the movement path of the bonding device moved parallel to the transport plane. This has the advantage in particular that the bonding device may now be moved horizontally, i.e., for example, does not project laterally beyond the intake device in a waiting position, but does in an operating position. The starting section of a new material roll may therefore be led to the intake device in the waiting position of the bonding device using a vertical movement component, and processed in the operating position of the bonding device.

The starting and end sections thus do not lie one on top of another in the course of the bond production, but rather press against one another in vertical orientation. Therefore, when the starting and end sections are pressed against one another, it must be ensured that the transverse edge of the starting section and the transverse edge of the end section delimit a two-layer material web section, the two transverse edges are thus located on opposite sides of the future bonding point, such as a bond seam. In this case, after the retraction into a horizontal orientation, a smooth transition results between the starting and end sections. If both transverse edges are located on the same side of a bond seam, for example, the starting and end sections only lie at approximately the same plane up to the bond seam after the retraction into the horizontal orientation, the sections from the bond seam up to the transverse edges would project out of this plane, however, which may sometimes cause problems in the later processing.

With horizontal mounting of the first material web, the end section may be bent over merely by the effect of gravity, or by forced guidance. Moreover, the end section is bent into a plane inclined to the transport plane by the effect of gravity or forced guidance, in that it is implemented as the free end of the first material web held horizontally at the end in an intake device, and the starting section is implemented as the free end of the second material web held at the beginning in a pre-tensioning unit, the starting section being pressed flatly overlapping against the end section by a vertical movement component of the pre-tensioning unit in relation to the intake device. According to claim 2, the starting section may be folded upward in the course of the vertical movement component by a deflection unit, such as a deflection strip. A welding unit is used as the preferred bonding device, so that according to claim 3, the starting section and the end section are bonded to one another in a tension-resistant way within the two-layer material web section by a weld bond.

Claim 4 relates to a device for bonding the outgoing end section of a first material web, which extends in a horizontal transport plane along a horizontal transport direction over a web-processing machine, to the incoming starting section of a second material web, which is located in a reserve area, an intake device being provided, in which an end section implemented as a free end of the first material web is held horizontally at the end, the intake device being equipped below the transport plane with a bonding device movable parallel to the transport direction for the tension-resistant bonding of the end section to the starting section pressed flatly overlapping against the end section. According to the present invention, a pre-tensioning unit pivotable using a vertical movement component is provided in the reserve area, in which a starting section implemented as the free end of the second material web is held at the beginning, the pre-tensioning unit being movable from a first pivot position, in which it is at a distance from the intake device, using a pivot movement directed downward into a second pivot position, in which it is located adjacent to the intake device and presses the starting section flatly overlapping against the end section. Because the first material web is held horizontally at the end, and the end section is implemented as a free end, the end section thus bends downward because of gravity. If the end section is selected as sufficiently long, it extends up into the movement path of the bonding device moved parallel to the transport plane.

The starting section may also be pressed manually against the end section, for example. In the interest of more rapid material roll changing, however, a pre-tensioning unit pivotable using a vertical movement component is provided in the reserve area, in which a starting section of the second material web implemented as a free end is held at the beginning, the pre-tensioning unit being movable from a first pivot position, in which it is at a distance from the intake device, using a downwardly directed pivot movement into a second pivot position, in which it is located adjacent to the intake device and the starting section presses flatly overlapping against the end section.

As already noted, the transverse edge of the starting section and the transverse edge of the end section must delimit a two-layer material web section. The starting section, which is implemented as a free end and is also bent downward by the effect of gravity, for example, must therefore be folded upward before being laid on the end section. This may occur solely by the inertia of the starting section in the course of the downwardly directed pivot movement. However, the intake device may also be provided according to claim 5 with a vertically projecting deflection strip, which is situated in the movement path of the starting section during the downwardly directed pivot movement of the pre-tensioning unit.

According to claim 6, the bonding device is a welding unit having a welding strip, according to claim 7, the pre-tensioning unit being able to be provided with a vertical anvil plate, which is located in the movement path of the welding strip in the second pivot position.

After the bonding of starting and end sections, as will be explained in greater detail, the transport planes of the first and second material webs are still vertically offset. To make the intake of the two material webs easier, one of the two transport planes is thus to be leveled with the particular other. The mutual orientation of the pre-tensioning unit and the intake device in the various method steps may be caused by appropriate pivoting of the pre-tensioning unit. Alternatively or additionally thereto, however, according to claim 8, the intake device may also be implemented as vertically adjustable. For example, the intake device may be vertically adjusted after the bond production by the features of claim 8 in such a way that the two material webs again lie in the same transport plane.

Finally, claim 9 relates to a preferred application of the device according to the present invention having drum magazine, in which multiple material rolls are each held parallel to one another, and are situated so they are pivotable around a shared pivot axis parallel to the rotational axes of the material rolls. In these cases, the pivot movement of the pre-tensioning unit is ensured by the pivot movement of the material rolls of the drum magazine around the shared pivot axis. Therefore, according to claim 9, the second material web is wound on a material roll in the reserve area, which is mounted in a support frame so it is rotatable around a support axis, and the pre-tensioning unit is connected to the support axis of the material roll, the material roll being situated so it is pivotable around a further pivot axis parallel to its support axis, preferably with further material rolls situated in parallel.

The present invention is explained in greater detail in the following on the basis of the attached drawings.

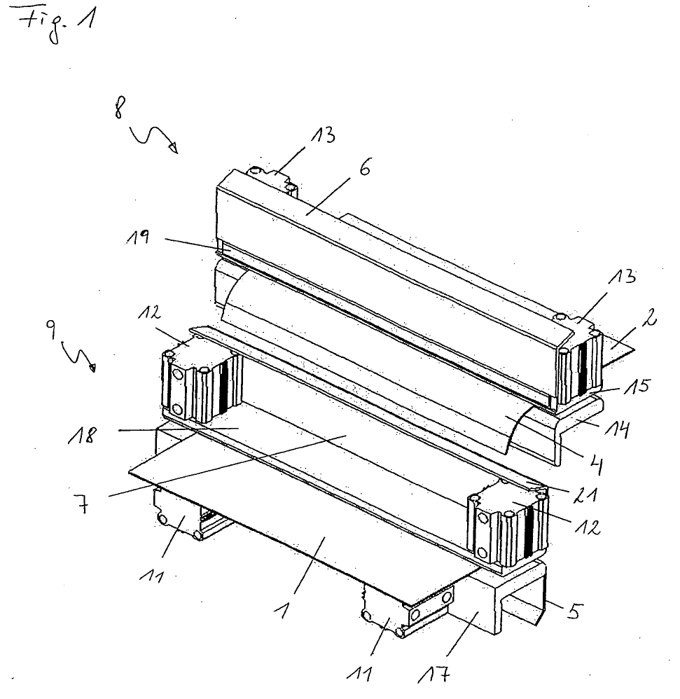

FIG. 1 shows a perspective illustration of an embodiment of a device according to the present invention in a first pivot position of the pre-tensioning unit,

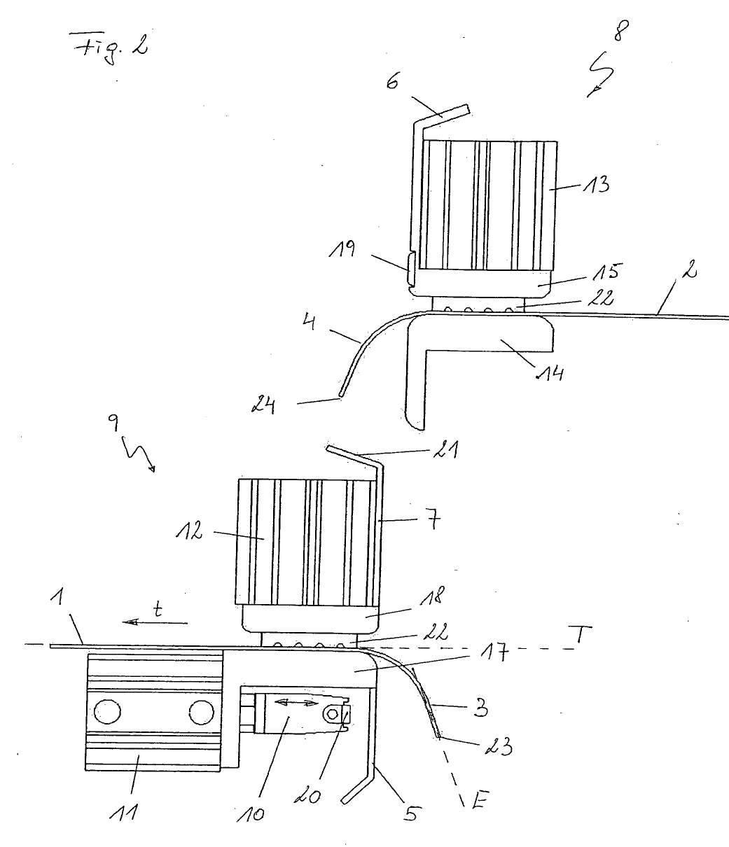

FIG. 2 shows a side view of the device from FIG. 1,

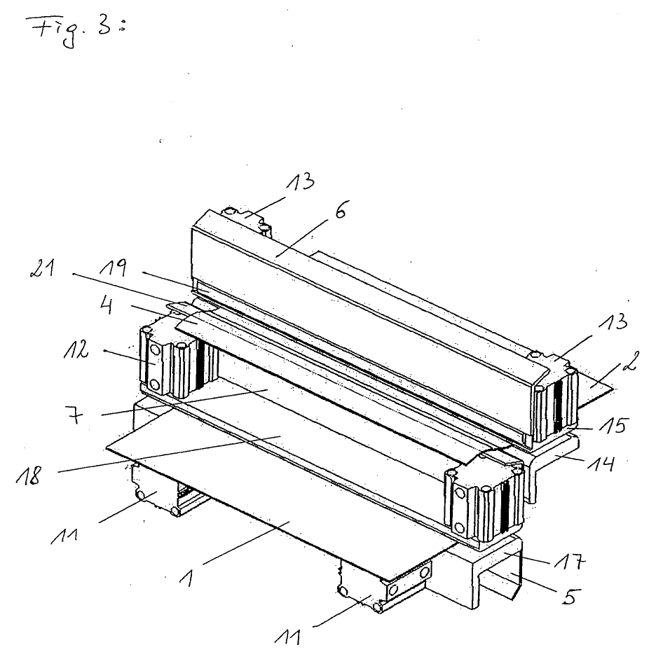

FIG. 3 shows a perspective illustration of the embodiment of a device according to the present invention from FIG. 1 in an intermediate position during the transfer into a second pivot position,

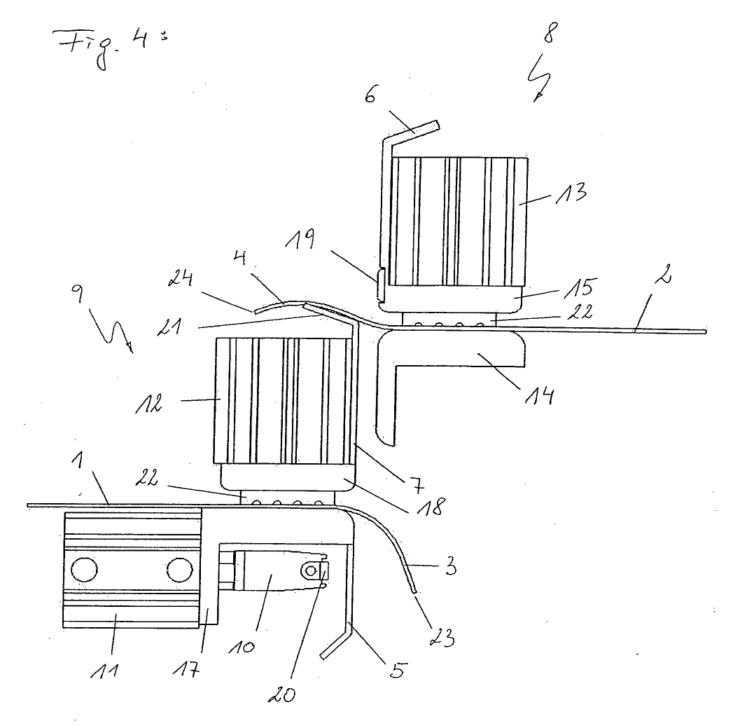

FIG. 4 shows a side view of the device from FIG. 3,

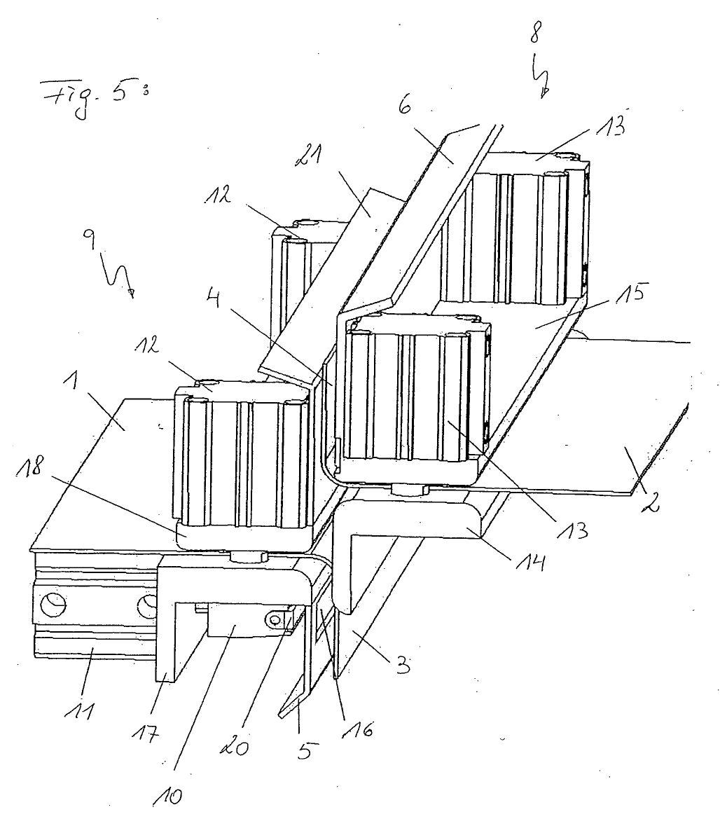

FIG. 5 shows a perspective illustration of the embodiment of a device according to the present invention from FIG. 1 in a further intermediate position during the transfer into the second pivot position,

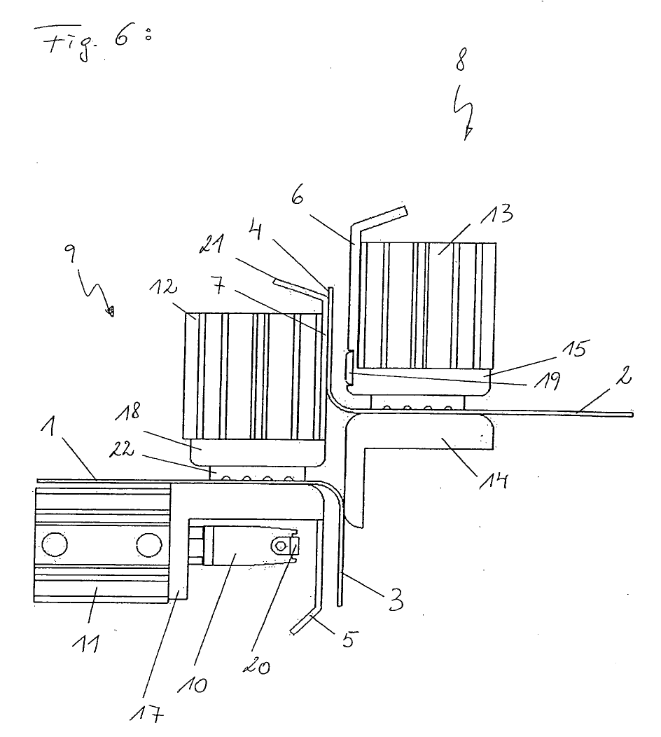

FIG. 6 shows a side view of the device from FIG. 5,

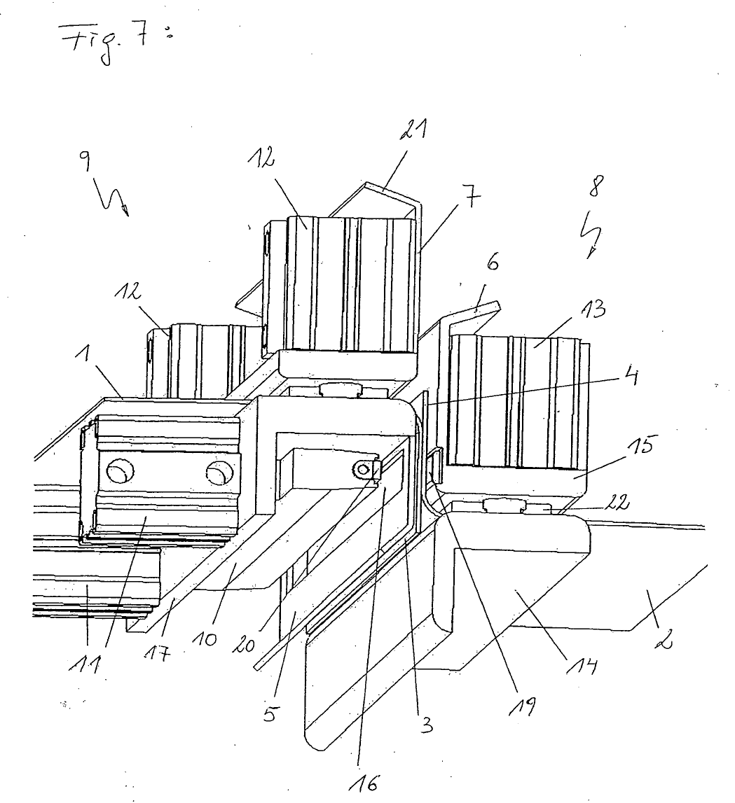

FIG. 7 shows a perspective illustration of the embodiment of the device according to the present invention from FIG. 1 in the second pivot position, in which the end section and the starting section press against one another,

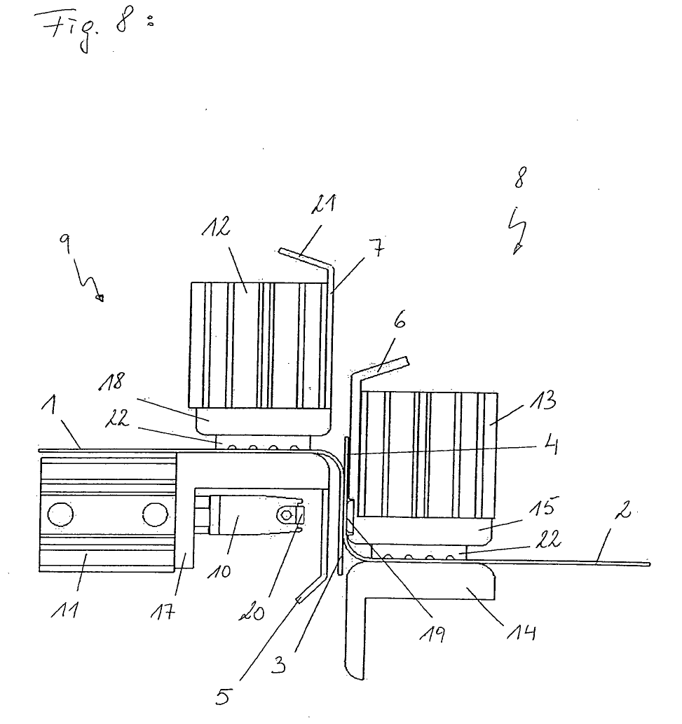

FIG. 8 shows a side view of the device from FIG. 7,

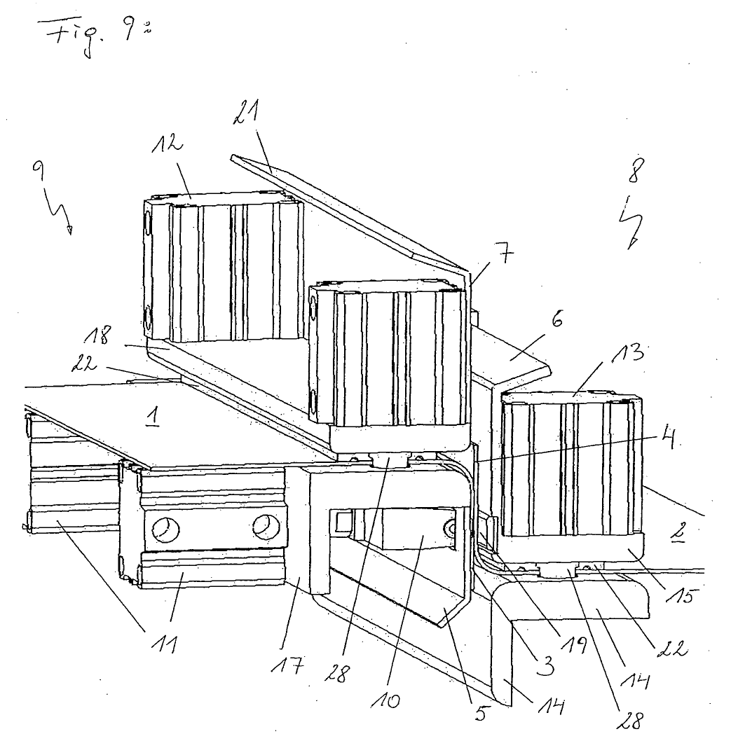

FIG. 9 shows a perspective illustration of the embodiment of a device according to the present invention from FIG. 1 in the second pivot position, in which the bonding device has been moved vertically into the operating position,

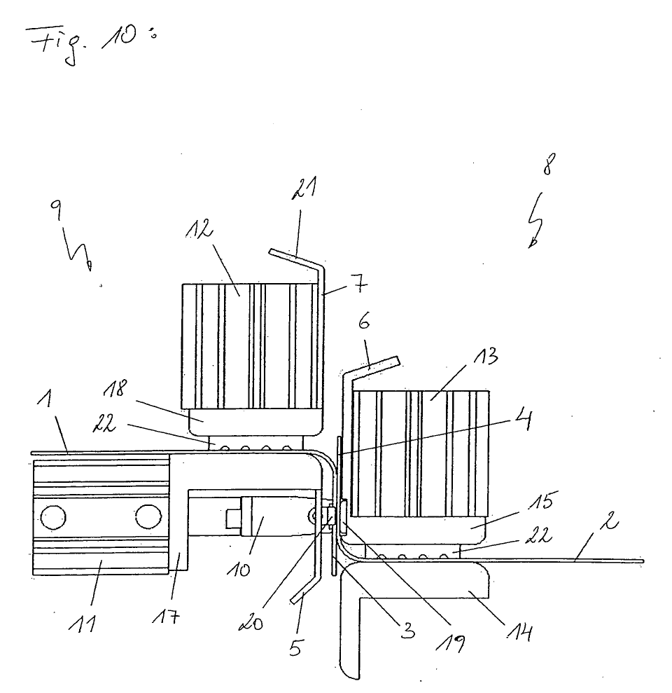

FIG. 10 shows a side view of the device from FIG. 9,

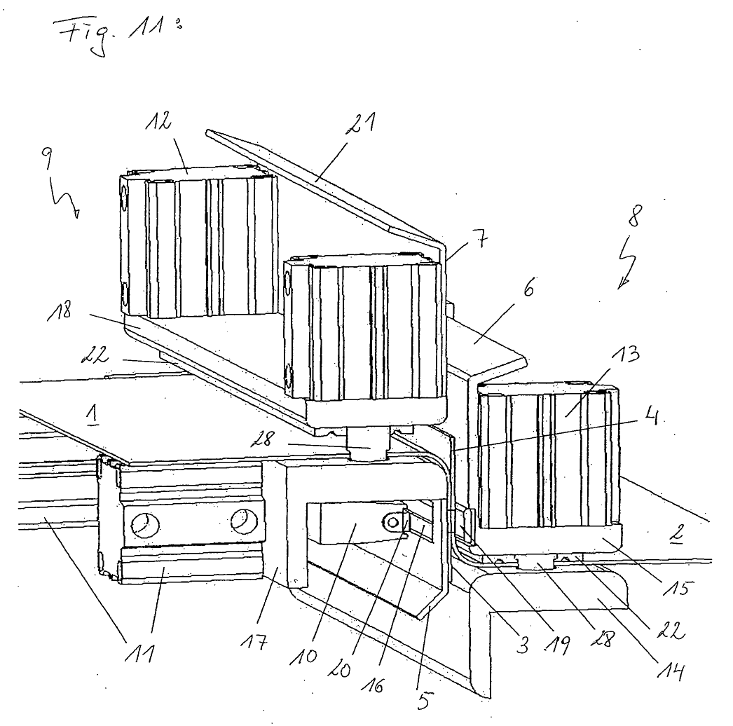

FIG. 11 shows a perspective illustration of the embodiment of a device according to the present invention from FIG. 1 in the second pivot position, in which the bonding device has been moved vertically into the waiting position again,

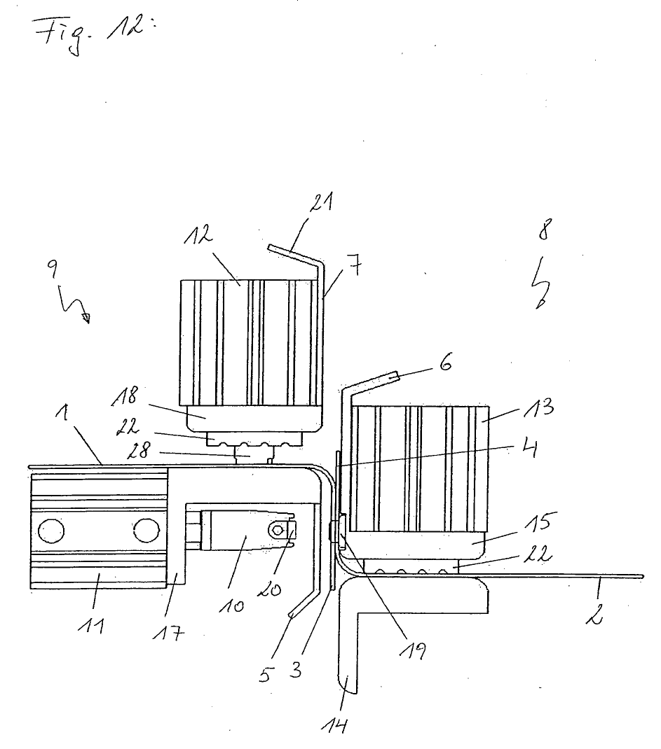

FIG. 12 shows a side view of the device from FIG. 11,

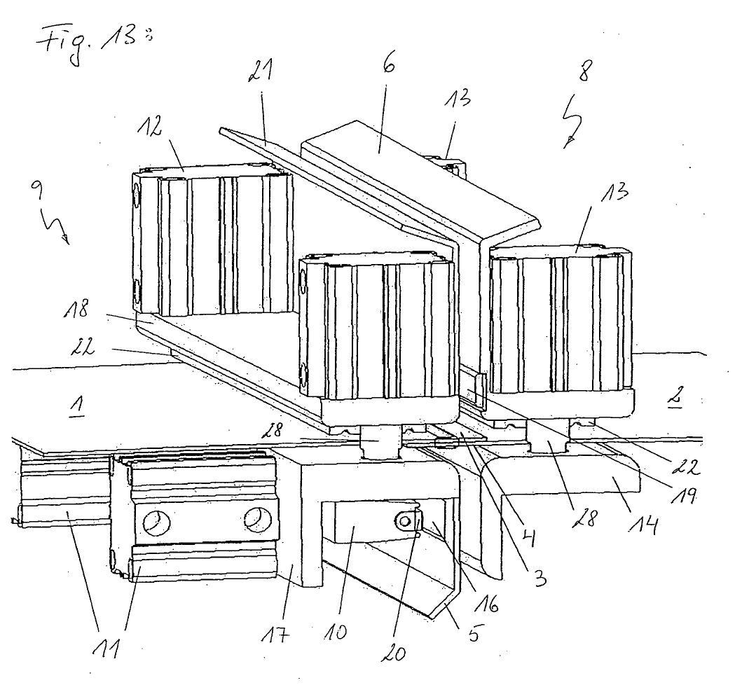

FIG. 13 shows a perspective illustration of the embodiment of a device according to the present invention from FIG. 1, in which the intake device and the pre-tensioning unit has been moved in relation to one another so that the two bonded material webs lie in the same transport plane,

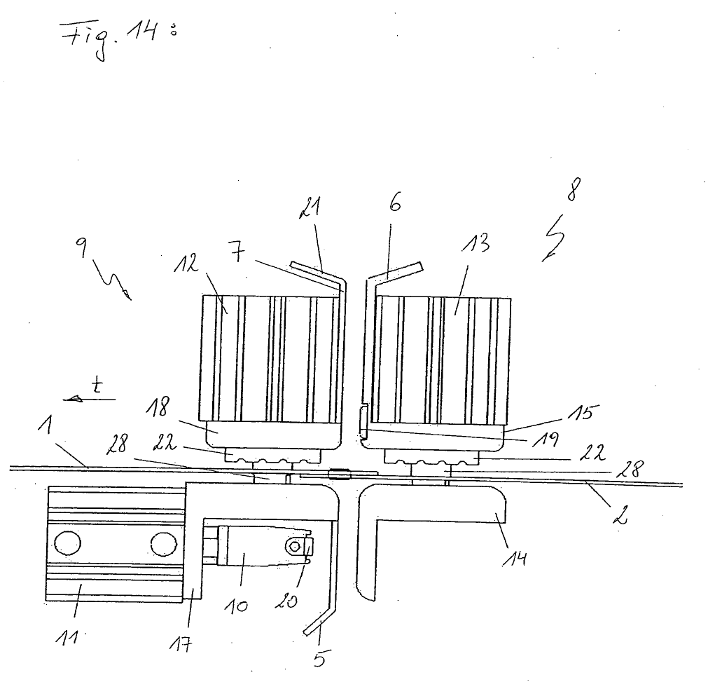

FIG. 14 shows a side view of the device from FIG. 13, and

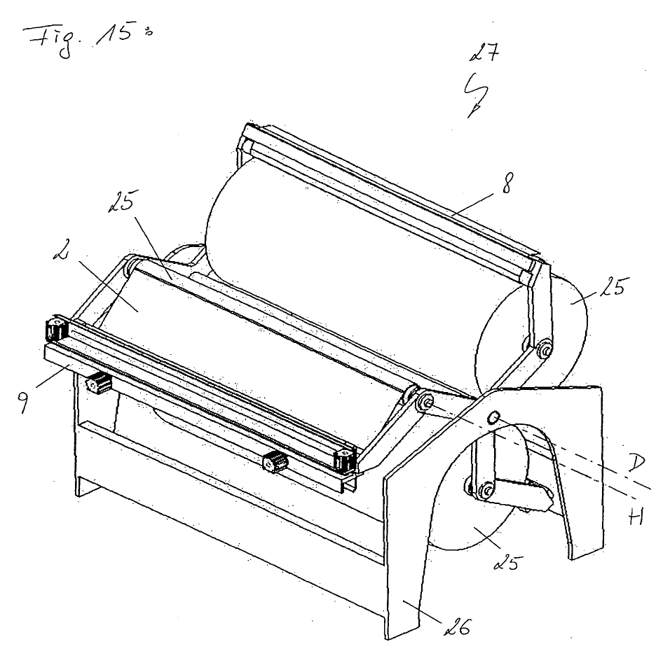

FIG. 15 shows a perspective illustration of a drum magazine as a reserve area, in which multiple material rolls are held in a roll changer.

FIG. 1 shows a perspective view of the pre-tensioning unit 8 and the downstream intake device 9. The intake device 9 has a base plate 18 and an angle bracket 17 spaced apart slightly from the base plate 18 with the aid of spacers 28, a first material web 1 being able to be clamped between the base plate 18 and the horizontal leg of the angle bracket 17. The angle bracket 17 lies below the base plate 18 and thus below the transport plane T of the clamped first material web 1. To be able to fix the material web 1 between the base plate 18 and the angle bracket 17, pneumatic cylinders 12 having vertically adjustable stamps 22 are situated on the base plate 18. As may be inferred from FIGS. 1 and 2, when a material web 1 is inserted, the end section 3 projects somewhat beyond the angle bracket 17. The first material web 1 is thus held horizontally by an end section 3 implemented as a free end at the end. The term “free end” is understood to mean that no forces are exerted on the laterally projecting end section by the intake device 9. The free end 3 is therefore only subject to the effect of gravity, which bends the free end downward into a plane E inclined to the transport plane T, if its intrinsic weight is sufficient for this purpose. Otherwise, forced guiding, which folds the free end 3 downward, is to be provided, for example, with the aid of the angle bracket 17.

A bonding device 10 is situated below the horizontal leg of the angle bracket 17, which is preferably a welding device 10 having a welding strip 20. Further pneumatic cylinders 111 are situated on the vertical leg of the angle bracket 17, which ensure adjustability of the welding device 10 in the horizontal direction (along the double arrow in FIG. 2).

Moreover, a screen 5 projects downward from the horizontal leg of the angle bracket 17, and lies opposite to the vertical leg of the angle bracket 17. The welding device 10 is located in a waiting position in FIG. 1 and FIG. 2, i.e., between the vertical leg of the angle bracket 17 and the screen 5. The screen 5 is to be provided with an opening 16 in the movement path of the welding strip 20.

The pre-tensioning unit 8 also has a base plate 15 and an angle bracket 14, a second material web 2 being able to be clamped between the base plate 15 and the horizontal leg of the angle bracket 14. The base plate 15 is again held at a slight distance from the horizontal leg of the angle bracket 14 with the aid of spacers 28. To be able to fix the material web 2 between the base plate 15 and the angle bracket 14, pneumatic cylinders 13 having vertically adjustable stamps 22 are situated on the base plate 15. As may be inferred from FIGS. 1 and 2, when a second material web 2 is inserted, the starting section 4 projects somewhat beyond the angle bracket 14. The second material web 2 is thus held on a starting section 4 implemented as a free end at the beginning. The term “free end” is again understood to mean that no forces are exerted on the starting section by the pre-tensioning unit 8. The free end 4 is therefore solely subject to the effect of gravity, which bends the free end 4 downward, if its intrinsic weight is sufficient for this purpose. Furthermore, the pre-tensioning unit 8 has a screen 6, which projects from the base plate 15. The screen 6 is provided with an anvil plate 19 made of heat-resistant material, such as Teflon.

The end section 3 has a transverse edge 23 running perpendicularly to the longitudinal extension of the first material web 1, and the starting section 4 has a transverse edge 24 running perpendicularly to the longitudinal extension of the material web 2.

The pre-tensioning unit 8 is held so it is pivotable using a vertical movement component, it being movable from a first pivot position, in which it is at a distance from the intake device 9 (see FIGS. 1 and 2), using a pivot movement directed downward into a second pivot position, in which it is located adjacent to the intake device 9 and the starting section 4 presses flatly overlapping against the end section 3 (see FIGS. 7 through 12).

As will be explained on the basis of FIG. 15, the pre-tensioning unit 8 may be a part of a correspondingly designed roll changer, for example, in which multiple material rolls 25 are each held parallel to one another, and which are situated so they are pivotable around a shared pivot axis D parallel to the rotational axes of the material rolls 25. In these cases, the pivot movement of the pre-tensioning unit 8 is ensured by the pivot movement of the material rolls 25 of the roll changer around the shared pivot axis D.

The mode of operation of the device according to the present invention with the aid of the method according to the present invention is as follows. In the course of a pivot movement of the pre-tensioning unit 8, it moves on a path shaped like a circular arc from a first pivot position, in which it is at a distance from the intake device 9 (FIGS. 1 and 2), toward the intake device 9 (FIGS. 3 and 4) and finally advances from above in front of the intake device 9, where it stops in a second pivot position (FIGS. 7 through 12). As is obvious from FIGS. 1 and 2, the starting section 4 may be bent downward because of the effect of gravity, if its intrinsic weight is sufficient for this purpose. Otherwise it projects laterally in a plane. It may already be folded upward because of its inertia in any case in the course of the downwardly directed pivot movement of the pre-tensioning unit 8, but it is nonetheless advantageous to provide a deflection strip 7, which is situated in the movement path of the starting section 4 during the downwardly directed pivot movement of the pre-tensioning unit 8. In this case, the transverse edge 24 of the starting section 4 abuts the angled area 21 of the deflection edge 7, and then slips outward. Finally, a configuration as shown in FIGS. 3 and 4 is reached, in which the starting section 4 rests on the angled area 21 of the deflection edge 7. If the pre-tensioning unit 8 moves further downward, the starting section 4 is finally pulled through between the deflection strip 7 and the screen 6 (see FIGS. 5 and 6). The end section 3 is engaged by the vertical leg of the angle bracket 14 and oriented vertically.

FIG. 7 and FIG. 8 show the pre-tensioning unit 8 in its second pivot position, in which it is located in front of the intake device 9. The intake device 9 and the pre-tensioning unit 8 are shown in a perspective view from below in FIG. 7, so that the welding unit 10 having the welding strip 20 is particularly clearly visible. In this pivot position, the starting section 4 presses flatly overlapping against the end section 3, the transverse edge 24 of the starting section 4 and the transverse edge 23 of the end section 3 delimiting a two-layer material web section. The latter is achieved by the reversal described above of the starting section 4 with the aid of the deflection strip 7. As is additionally obvious, the starting section 4 and the end section 3 are oriented approximately vertically, so that they are held by the screen 5 and the screen 6. It is also immediately obvious that the length of the starting section 4 and the end section 3 must be selected as sufficiently large so that they are engaged by the welding strip 20.

The actual bond production now occurs with the aid of the welding unit 10. By actuating the pneumatic cylinder 11, the welding strip 20 is moved in the horizontal direction from a waiting position into the operating position, i.e., to the right in relation to FIG. 9. It first penetrates the opening 16 in the screen 5, and is then incident on the two-layer material web section which is formed by the overlapping starting section 4 and end section 3. The welding strip 20 presses the two-layered material web section against the anvil plate 19 of the screen 6 and welds the starting section 4 to the end section 3 (FIGS. 9 and 10).

Of course, other types of bond production between end section 3 and starting section 4 are also conceivable, for example, by gluing or clamping, or also using special cutting before the bond production. It is only essential that the bond is capable of transmitting the tensile force exerted by the web-processing machine in the transport direction t to the incoming starting section 4 of the new material web 2.

After an action time sufficient for producing a tension-resistant bond, the welding strip 20 is moved back into its waiting position, by which it releases the starting section 4 and the end section 3 again (FIGS. 11 and 12). Because the planes of the two material webs 1 and 2, which are now bonded to one another, are offset vertically, the pre-tensioning unit 8 and the intake device 9 may be moved in relation to one another so that the material webs 1 and 2 lie in the same plane. This may be performed either by raising the pre-tensioning unit 8 or by lowering the intake device 9. In the course of the vertical orientation of the webs 1 and 2, it is advantageous to release the outgoing material web 1 as shown in FIGS. 11 and 12, i.e., remove the stamp 22 of the pneumatic cylinder 12 of the intake device 9. In contrast, if the incoming end of the material web 2 remains clamped by the stamp 22 of the pneumatic cylinder 13 of the pre-tensioning unit 8, the material web 1 may slip through between the base plate 18 and the angle bracket 17 of the intake device 9 in the course of the level equalization between pre-tensioning unit 8 and intake device 9.

Finally, the pre-tensioning unit 8 and the intake device 9 reach the mutual positioning shown in FIGS. 13 and 14, in which the outgoing material web 1 and the new material web 2 are located approximately in the same plane. The two material webs 1 and 2 are now bonded to one another in a tension-resistant way, so that an intake force of the web-processing machine in the transport direction t is transmitted to the incoming material web 2. For this purpose, the stamp 22 of the pneumatic cylinder 13 of the pre-tensioning unit 8 is also raised, so that the material web 2 is released.

Finally, FIG. 15 relates to a preferred application of the device according to the present invention having drum magazines as the reserve area 27, in which multiple material rolls 25 are each held parallel to one another, and which are situated so they are pivotable around a shared pivot axis D parallel to the rotational axes of the material rolls 25. In these cases, the pivot movement of the pre-tensioning unit 8 is ensured by the pivot movement of the material rolls 25 of the drum magazine around the shared pivot axis D. The second material web 2 is thus unwound from one of the material rolls 25 in the reserve area, the material rolls 25 being mounted in a support frame 26 so they are each rotatable around a support axis H, and the pre-tensioning unit 8 is connected to the particular support axis H of the material roll 25.

With the aid of the method and/or the device according to the present invention it is possible to avoid longer shutdown times of the entire plant during a change of the material webs 1, 2. In particular, the bonding of the starting section 4 of a new material web 2 to the end section 3 of a consumed material web 1 may occur automatically. The type of bond production between starting section 4 and end section 3 may also be used on drum magazines, i.e., on a stockpile of the material rolls 25 in roll changers, in which the new material roll 25 is led to the end section 3 via a pivot movement.

1: A method for bonding the outgoing end section (3) of a first material web (1), which is supplied to a web-processing machine in a transport plane (T) along the transport direction (t), to the incoming starting section (4) of a second material web (2), which is led from a reserve area (27) to the end section (3) of the first material web (1), the end section (3) being bent into a plane (E) inclined to the transport plane (T) in a first step, the starting section (4) being pressed flatly overlapping against the end section (3) in a second step, so that the transverse edge (24) of the starting section (4) and the transverse edge (23) of the end section (3) delimit a two-layer material web section, and the starting section (4) and the end section (3) being bonded to one another in a tension-resistant way within the two-layer material web section by a bonding device (10) moved parallel to the transport direction (t) in a third step, wherein the end section (3) is implemented as a free end of the first material web (1) held horizontally at the end in an intake device (9), and the starting section (4) is implemented as a free end of the second material web (2) held at the beginning in a pre-tensioning unit (8), the starting section (4) being pressed flatly overlapping against the end section (3) by a vertical movement component of the pre-tensioning unit (8) in relation to the intake device (9).

2: The method according to claim 1, wherein the starting section (4) is folded upward by a deflection strip (7) in the course of the vertical movement component.

3: The method according to claim 1, wherein the starting section (4) and the end section (3) are bonded to one another in a tension-resistant way within the two-layer material web section by a weld bond.

4: A device for bonding the outgoing end section (3) of a first material web (1), which extends in a horizontal transport plane (T) along a horizontal transport direction (t) over a web-processing machine, to the incoming starting section (4) of a second material web (2), which is located in a reserve area (27), an intake device (9) being provided, in which an end section (3) of the first material web (1) implemented as a free end is held horizontally at the end, the intake device (9) being equipped below the transport plane (T) with a bonding device (10) movable parallel to the transport direction (t) for the tension-resistant bonding of the end section (3) to the starting section (4), which is pressed flatly overlapping against the end section (3), wherein a pre-tensioning unit (8), which is pivotable using a vertical movement component, is provided in the reserve area (27), in which a starting section (4) of the second material web (2) implemented as a free end is held at the beginning, the pre-tensioning unit (8) being movable from a first pivot position, in which it is spaced apart from the intake device (9), using a downwardly directed pivot movement into a second pivot position, in which it is located adjacent to the intake device (9) and the starting section (4) presses flatly overlapping against the end section (3).

5: The device according to claim 4, wherein the intake device (9) is provided with a vertically projecting deflection strip (7), which is situated in the movement path of the starting section (4) during the downwardly directed pivot movement of the pre-tensioning unit (8).

6: The device according to claim 4, wherein the bonding device (10) is a welding unit (10) having a welding strip (20).

7: The device according to claim 6, wherein the pre-tensioning unit (8) is provided with a vertical anvil plate (19), which is located in the movement path of the welding strip (20) in the second pivot position.

8: The device according to claim 4, wherein the intake device (9) is vertically adjustable.

9: The device according to claim 4, wherein the second material web (2) is wound on a material roll (25) in the reserve area (27), which is mounted in a support frame (26) so it is rotatable around a support axis (H), and the pre-tensioning unit (8) is connected to the support axis (H) of the material roll (25), the material roll (25) being situated so it is pivotable around a further pivot axis (D) parallel to its support axis (H), preferably with further material rolls (25) situated in parallel.
